(19) United States
(12) Patent Application Publication
(10) Pub. No.: US 2025/0081980 A1
(43) Pub. Date: Mar. 13, 2025

(54) Methods and Systems for Tea Extraction

(71) Applicant: Florida Food Products, LLC, Eustis, FL (US)

(72) Inventors: Kenneth J. Simone, Longwood, FL (US); D. Scott Lineback, Longwood, FL (US); Rajesh R. Jetti, Zionsville, IN (US); Danish Yazdani, Chester, NY (US); Gregg Lance Lehmberg, Westfield, NJ (US)

(73) Assignee: Florida Food Products, LLC, Eustis, FL (US)

(21) Appl. No.: 18/883,931

(22) Filed: Sep. 12, 2024

Related U.S. Application Data
(60) Provisional application No. 63/537,994, filed on Sep. 12, 2023.

(51) Int. Cl. A23F 3/18; A23F 3/20; A23F 3/22; A23F 3/30; A23F 3/42

(52) U.S. Cl. CPC A23F 3/18; A23F 3/20; A23F 3/22; A23F 3/30; A23F 3/423

(57) ABSTRACT

This disclosure relates to methods, systems and compositions for food coloring. Embodiments disclosed herein may include methods and systems for combining tea leaves and water to form a feed slurry; processing a feed slurry to at least partially remove a tea essence from the feed slurry, thereby obtaining a tea extract with a predetermined amount of one or more of an aroma or a flavor; and adjusting a color of the tea extract, thereby obtaining a coloring agent with a predetermined color-related feature, wherein the coloring agent is added in a predetermined amount to a food product to adjust a color of the food product. Embodiments may also including coloring compositions, which may include a dry tea extract, wherein an essence has been removed from the dry tea extract to a predetermined amount, and a color of the dry tea extract has been adjusted to have a predetermined color-related feature.

### CROSS REFERENCE TO RELATED APPLICATION(S)

This application claims priority to and the benefit of U.S. Provisional Patent Application No. 63/537,994, filed Sep. 12, 2023, the contents of which is incorporated herein by reference in its entirety.

### FIELD

The present disclosure relates to methods and systems for preparing a tea product.

### BACKGROUND

There are various food additives that are used for imparting various properties, such as, for example, a color, flavor, or aroma, when added to food or beverages, A problem with many of these food additives is that they often include harmful chemicals. There is a need for a natural food additives, and well as cost-effective methods and systems for producing such food additives.

### SUMMARY

In some aspects, described herein is a method for food coloring, the method including: combining tea leaves and water to form a feed slurry; processing the feed slurry to at least partially remove a tea essence from the feed slurry, thereby obtaining a tea extract with a predetermined amount of one or more of an aroma or a flavor; and adjusting a color of the tea extract, thereby obtaining a coloring agent with a predetermined color-related feature; wherein the coloring agent is added in a predetermined amount to a food product to adjust a color of the food product.

In some aspects, described herein is a method, further including adding the coloring agent to a food product.

In some aspects, described herein is a method, wherein the food product includes a batter, beer, bread, buns, cereals, chocolate, cookies, pastries, cough drops, spirits, liquor, confectionery, coatings, custards, decorations, fillings and toppings, potato chips, dessert mixes, doughnuts, fish and shellfish spreads, frozen desserts, condiments, pet foods, preserves, tablets, gravy, ice cream, sauces and dressings, soft drinks, sweets, vinegar, soups, teas, juice concentrates, crackers, or flavorings.

In some aspects, described herein is a method, wherein the tea leaves include black tea, green tea, or a combination thereof.

In some aspects, described herein is a method, wherein the processing includes performing at least one tea extraction of the feed slurry.

In some aspects, described herein is a method, wherein the processing further includes performing at least one tea stripping of the feed slurry, wherein the at least one tea stripping includes exposing the feed slurry to steam, air, inert gas, or a combination thereof.

In some aspects, described herein is a method, wherein the at least one tea extraction and the at least one tea stripping are performed simultaneously.

In some aspects, described herein is a method, wherein the at least one tea extraction and the at least one tea stripping are performed sequentially.

In some aspects, described herein is a method, wherein the at least one tea extraction includes extracting soluble and/or volatile components from the tea leaves.

In some aspects, described herein is a method, wherein the at least one tea extraction is performed using a spinning cone column, a batch extractor, counter-current extractor, or a combination thereof.

In some aspects, described herein is a method, wherein the processing includes at least one phase separation, the at least one phase separation being performed using a decanter, filtration, centrifugation, or a combination thereof.

In some aspects, described herein is a method, wherein the at least one phase separation is between each of at least one tea extraction step.

In some aspects, described herein is a method, wherein the at least one phase separation is performed at a temperature within a range of 40° C. to 90° C. to increase an amount of polyphenols in the tea extract.

In some aspects, described herein is a method, wherein the at least one phase separation is performed at a temperature within a range of 3° C. to about 40° C. to reduce an amount of polyphenols in the tea extract.

In some aspects, described herein is a method, further including concentrating or diluting the tea extract after the performing the at least one phase separation so as to obtain an amount of tea solids in a range of 10%-20% in the tea extract.

In some aspects, described herein is a method, wherein the concentrating is performed using reverse osmosis, membranes, evaporators, presses, or a combination thereof.

In some aspects, described herein is a method, wherein the diluting is performed by adding water to the tea extract.

In some aspects, described herein is a method, wherein the adjusting the color includes one or more of oxidizing of the tea extract, solubilizing of the tea extract, adjusting a pH of the solubilized tea extract, or a combination thereof.

In some aspects, described herein is a method, the oxidizing includes alkaline oxidation.

In some aspects, described herein is a method, wherein the solubilizing includes hydrogen peroxide (H2O2) solubilization, ozone solubilization, or a combination thereof.

In some aspects, described herein is a method, wherein the adjusting the pH includes adding an amount of acid sufficient to adjust the pH of the solubilized tea extract to between 5-7.

In some aspects, described herein is a method, further including concentrating the coloring agent so as to obtain an amount of tea solids in a range of about 25% to about 65% (w/w).

In some aspects, described herein is a method, further including post-processing of the coloring agent, wherein the post-processing includes one or more of centrifuging, evaporating, drying, or a combination thereof of the coloring agent.

In some aspects, described herein is a method, wherein the drying includes one or more of spray drying, freeze drying, vacuum belt drying, thermal spray drying, or a combination thereof.

In some aspects, described herein is a system for food coloring, including: a processing module configured to at least partially remove a tea essence from a feed slurry, thereby obtaining a tea extract with a predetermined amount of one or more of an aroma or a flavor, the feed slurry including tea leaves and water; and a reaction module configured to adjust a color of the tea extract, thereby obtaining a coloring agent with a predetermined color-related feature.

In some aspects, described herein is a system, wherein the processing module includes an extraction module.

In some aspects, described herein is a system, wherein the processing module includes a stripping module.

In some aspects, described herein is a system, wherein the processing module is configured to perform extraction and stripping of the feed slurry.

In some aspects, described herein is a system, wherein the tea leaves include black tea, green tea, or a combination thereof.

In some aspects, described herein is a system, further including a hopper for contacting the tea leaves and the water.

In some aspects, described herein is a system, wherein the processing module includes a spinning cone column, a batch extractor, counter-current extractor, or a combination thereof.

In some aspects, described herein is a system, further including a phase separation module between the processing module and the reaction module, the phase separation module including one or more of a centrifuge, decanter, belt press, filter, or a combination thereof.

In some aspects, described herein is a system, further including a concentrator module between the processing module and the reaction module, the concentrator module including one or more of an evaporator, a pump, a feed tank, a membrane system, a press, a reverse osmosis system, an agitator, a heat exchanger or a combination thereof.

In some aspects, described herein is a system, wherein the reaction module includes a heating module, a sparging module, a heat exchanger, at least one pump, or a combination thereof.

In some aspects, described herein is a system, wherein the reaction module includes a plurality of input channels configured to receive inputs such as a base, air, a solubilizer, an acid, or a combination thereof to perform oxidation, solubilization, or a pH adjustment of the tea extract.

In some aspects, described herein is a system, wherein the reaction module includes a sparging submodule operatively coupled to an oxygen source.

In some aspects, described herein is a system, further including a centrifuging submodule, a concentrator submodule, a drying submodule, or a combination thereof downstream of the reaction module.

In some aspects, described herein is a system, wherein the drying submodule is configured for spray drying, freeze drying, vacuum belt drying, thermal spray drying, or a combination thereof.

In some aspects, described herein is a system, wherein the reaction module includes a color measurement device.

In some aspects, described herein is a system, wherein the processing module includes a spinning cone column that is configured to perform extraction and stripping of the feed slurry.

In some aspects, described herein is a coloring composition including: a dry tea extract, wherein a color-related feature of the dry tea extract scales with an amount of solid-liquid extraction, oxidation, solubilization, and pH adjustment of a tea feed slurry; wherein the color-related feature includes one or more of an L-value, an A-value, a B-value, a haze value, or a combination thereof; and wherein the tea feed slurry includes a mixture of tea leaves and water.

In some aspects, described herein is a coloring composition, wherein the L-value ranges from between 5 and 28.

In some aspects, described herein is a coloring composition, wherein the A-value ranges from between 15 and 40.

In some aspects, described herein is a coloring composition, wherein the haze value ranges from between 5 and 20.

In some aspects, described herein is a coloring composition including: a dry tea extract, wherein an essence has been removed from the dry tea extract to a predetermined amount, and a color of the dry tea extract has been adjusted to have a predetermined color-related feature, the color-related feature being one or more of an L-value, an A-value, a B-value, a haze value, or a combination thereof.

In some aspects, described herein is a coloring composition, wherein the L-value ranges from between 5 and 28.

In some aspects, described herein is a coloring composition, wherein the A-value ranges from between 15 and 40.

In some aspects, described herein is a coloring composition, wherein the haze value ranges from between 5 and 20.

### BRIEF DESCRIPTION OF THE DRAWINGS

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1 provides an exemplary method for preparing a tea product of the present disclosure;

FIGS. 2A-2B provide an exemplary system that can be utilized to carry out a method of preparing a tea product of the present disclosure, whereby the system includes extraction and stripping modules that are separate (FIG. 2A) or combined (FIG. 2B);

FIG. 3 provides an exemplary flow chart for carrying out the methods of the present disclosure on a continuous and/or automated basis.

While the above-identified drawings set forth presently disclosed embodiments, other embodiments are also contemplated, as noted in the discussion. The present disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The present disclosure provides methods and systems for preparing a tea product. In some embodiments, the methods and systems of the present disclosure allows for an adjustment of one or more of color, aroma, and flavor of the tea product to use such adjusted tea product for enhancing one or more of color, aroma, or flavor of a food product in a cost-effective and natural manner.

In some aspects, the present disclosure provides a method for preparing a tea product. In some embodiments, the method comprises combining tea leaves and water to form a feed slurry. In some embodiments, the method comprises performing at least one extraction on the feed slurry to obtain a processed slurry with soluble tea solids in the liquid. In some embodiments, the method comprises performing at least one separation step of the processed slurry to obtain a tea extract and an undissolved tea solids. In some embodiments, the method comprises performing one or more of a concentrating and a diluting of the tea extract to obtain a desired amount of a tea solids in the tea extract. In some embodiments, the method comprises reacting the tea extract. In some embodiments, the method comprises and post-processing of the reacted tea extract to form the tea product. In some embodiments, the reacting includes oxidizing of the tea extract, followed by solubilizing of the oxidized tea extract. In some embodiments, the solubilizing of the oxidized tea extract is followed by pH adjusting of the solubilized tea extract. In some embodiments, the post-processing is based at least on a measuring of at least one feature, such as, for example, a color and a haze, of the reacted tea extract. In some embodiments, the resulting tea product is instant tea. In some embodiments, the method optionally comprises performing at least one tea stripping of the processed slurry to strip a desired level of tea essence (for example, aroma and flavor) from the tea product.

In some aspects, the present disclosure relates generally to systems for preparing a tea product. In some embodiments, the systems described herein may include an extraction module for performing at least one extraction of the feed slurry to obtain the processed slurry containing soluble tea solids. In some embodiments, the system of the present disclosure can also include a stripping module for optionally performing at least one tea stripping of the feed slurry to obtain the processed slurry and the tea essence. In some embodiments, the systems described herein may include an extraction module and a stripping module, separate or in combination, for obtaining the tea extract and the undissolved tea solids from the processed slurry; a concentrating/diluting module for either concentrating or diluting the tea extract to obtain the desired amount of tea solids in the tea extract; and a reaction module for allowing the tea slurry to undergo reactions, such as, for example, oxidation, solubilization, and pH adjustment.

In some aspects, the present disclosure provides methods and systems for adjusting one or more of an aroma, flavor or color of the tea extract, such that the resulting product can then be used to enhance these properties or a food product.

In some aspects, described herein is a method for food coloring, the method including: combining tea leaves and water to form a feed slurry; processing the feed slurry to at least partially remove a tea essence from the feed slurry, thereby obtaining a tea extract with a predetermined amount of one or more of an aroma or a flavor; and adjusting a color of the tea extract, thereby obtaining a coloring agent with a predetermined color-related feature; wherein the coloring agent is added in a predetermined amount to a food product to adjust a color of the food product.

In some aspects, described herein is a system for food coloring, including: an extraction module configured to perform at least one tea extraction to extract non-volatile components from the tea leaves in the feed slurry, thereby obtaining a tea extract with a predetermined amount of one or more of an aroma or a flavor, the feed slurry including tea leaves and water; and a reaction module configured to adjust a color of the tea extract, thereby obtaining a coloring agent with a predetermined color-related feature.

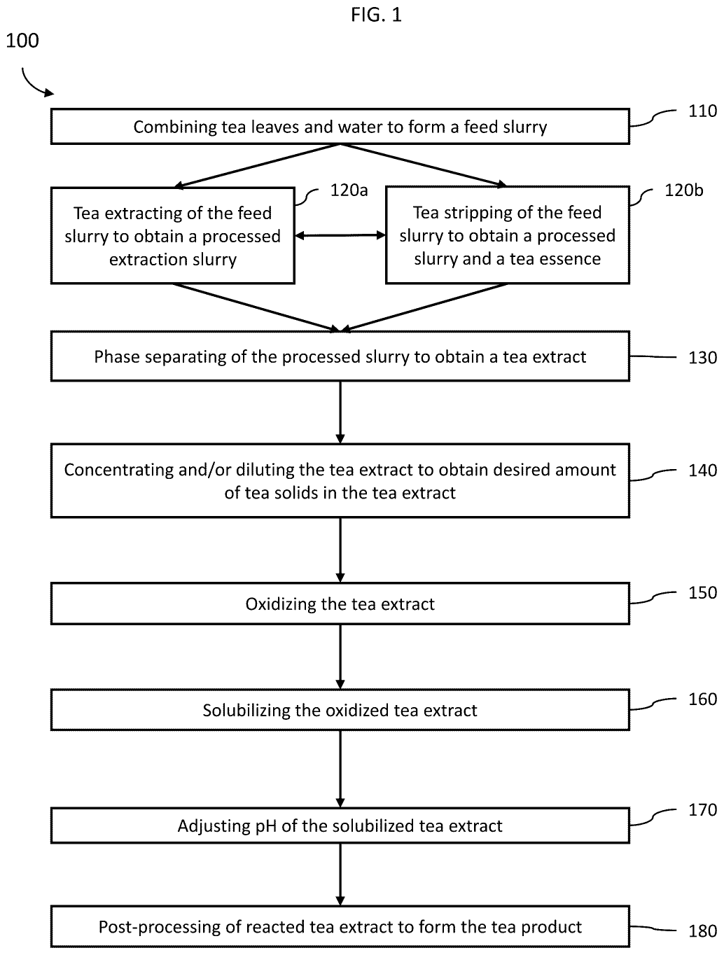

FIG. 1 is a flowchart of an example process 100 for preparing a tea product of the present disclosure. At step 110, the raw materials, e.g., tea leaves and water, may be gathered for preparing a feed slurry. Preparing the raw materials may begin by providing tea leaves. The tea leaves may be, for example, black tea, green tea, or both black and green tea. In some embodiments, the tea leaves and water may be combined using a hopper or a tank. In some embodiments, the black tea and green tea may be combined at a ratio for achieving a desired level of tea polyphenols in the resulting feed slurry, thus affecting a color of the tea products, as well as a flavor, a chemistry, and a cost of the resulting tea products. In some embodiments, the tea polyphenols may comprise one or more of the following: catechins, theaflavins, and thearubigins. The tea polyphenols may be further involved in oxidation reactions, discussed in more detail below, to create a darker product during the reaction and for color adjustment. In some embodiments, the black tea and green tea are combined in a ratio of 100-0:0-100. In some embodiments, the black tea and green tea are combined in a ratio of 90:10, 80:20, 70:30, 60:40, 50:50, 40:60, 30:70, 20:80, or 10:90. The water is added to the tea leaves to prepare the feed slurry.

After step 110, the feed slurry is then subjected to tea extracting at step 120a to produce a processed extracted slurry. In some embodiments, the tea extracting is performed in a tea extracting module. At step 120a, the tea extracting comprises extracting soluble and/or volatile components, e.g., an aroma, flavors, and other volatile components or non-volatile components from the tea in the feed slurry using a tea extracting module. In some embodiments, the tea extracting comprises liquid-liquid or solid-liquid extraction. In general, non-volatile components are known to be removed from the feed slurry during tea extracting. In some embodiments, the tea extracting module is operated at a specified temperature. In some embodiments, the tea extracting module is operated at a temperate between about 90° C. to about 99° C., between about 80° C. to about 89° C., between about 70° C. to about 79° C., between about 60° C. to about 69° C., or between about 50° C. to about 59° C. The tea extracting may be a batch or a continuous process. For example, contact of water and tea, such as from the feed slurry, allows the extraction of non-volatile components—e.g., caffeine, minerals, carbohydrates, protein, etc.—to occur. In some embodiments, the minerals comprise one or more of potassium, calcium, and magnesium. Tea extracting may be performed with any type of extracting module, such as, for example, a spinning cone column, a batch extractor, counter-current extractor, or a combination thereof. In some embodiments, the raw tea leaves and water are mixed to create the feed slurry at a desired ratio of tea leaf vs. water. The resulting slurry is placed into a spinning cone column to perform extraction. In some embodiments, the tea extracting is continued until the desired amounts of tea essence and extract are obtained. It should be noted that depending on a particular temperature range at which the extraction is carried out, the extraction step may allow for some volatile components to be removed from tea leaves in the feed slurry, in addition to non-volatile components. In some embodiments, the volatile components comprise one or more of: linalool, phenylacetaldehyde, benzaldehyde, methyl salicylate, beta-ionone, trans-2-hexenal. In some embodiments, the volatile components comprise aroma/aromatics and flavor(s).

In some embodiments, the method may include step 120b comprising a stripping of the processed slurry. In some embodiments, the tea stripping is optional, such that only tea extracting is performed on the feed slurry. During the stripping step, the volatile components or essence may be stripped. In some embodiments, the tea stripping is performed in a tea stripping module. In some embodiments, the tea stripping comprises gas-liquid stripping. In some embodiments, the volatile components comprise one or more of: linalool, phenylacetaldehyde, benzaldehyde, methyl salicylate, beta-ionone, and trans-2-hexenal. In some embodiments, the volatile components comprise aroma/aromatics and flavor(s). In some embodiments, the tea stripping module is operated at a specified temperature. The tea stripping may be a batch or a continuous process. Exposing the feed slurry to a stripping composition, which may include, for example, steam, air, or an inert gas, allows the stripping to occur. The stripping composition then strips the feed slurry of the volatile components and the stripping composition is condensed to collect the tea essence for further use. In some embodiments, the condensing of the stripping composition, after stripping the volatile components, may be performed by passing the stripping composition through a condenser. Tea stripping may be performed with any type of stripping module, such as, for example, a spinning cone column, a packed column, a tray column or a combination thereof. In some embodiments, the raw tea leaves and water are mixed to create the feed slurry at a desired ratio of tea leaf vs. water. The resulting slurry is placed into a spinning cone column to perform stripping. In some embodiments, the tea essence may be stripped by flowing a stripping composition at a chosen strip rate through the spinning cone column. In some embodiments, the tea stripping is continued until the desired amounts of tea essence and extract are obtained.

In some embodiments, the tea extracting and tea stripping can be performed in a single unit of operation, such as, for example, in a spinning cone column. In some embodiments, the tea extracting may be performed simultaneously. In some embodiments, the tea extracting and tea stripping may be performed sequentially.

It should be noted that a combination of an optimum feed slurry ratio, strip ratio, and temperature during extracting and, optionally, stripping, ensures the captured essence is representative of the character of the starting tea, and the tea solids still having a desired level of aroma active compounds to ensure a tea product has the correct blend of color, flavor, aroma, astringency and mouthfeel in the finished tea product. In some embodiments, stripping may be adjusted so as to strip a higher or lower amount of the captured essence, thereby impacting characteristics of the final product such that the essence is not representative of the character of the starting tea. In some embodiments, a feed slurry may be adjusted for a desired amount of tea solids. In some embodiments, an optimum feed slurry ratio may have tea solids within a range of about 5% to about 10% (w/w), of about 4% to about 10% (w/w), of about 4% to 12% (w/w), of about 2% to about 10% (w/w), of about 2% to about 14% (w/w). In some embodiments, the stripping is adjusted so as to obtain a tea product with a relatively low flavor and/or aroma. In some embodiments, a temperature of the stripping may be within a range of about 25° C. to about 120° C., and in some embodiments of about 90° C. to about 99° C. In some embodiments, the temperature may be optimized by using a pressurized reactor. In some embodiments, the temperature may be optimized by using a reactor under vacuum. Such optimum ranges may be used to ensure high quality tea essence, extract, and optimum yield of the methods described herein. In some embodiments, the extraction and the optional stripping can be carried out in a spinning cone column.

At step 130, the processed slurry may undergo phase separation, such as, for example, via decanter, filtration, centrifugation, to form a clarified tea extract. In some embodiments, the clarified tea extract may be in a liquid form. Phase separation separates any undissolved tea solids from the tea extract, such that the undissolved tea solids may be saved for further use or discarded as waste. In some embodiments, a phase separation is performed between each of a plurality of tea extraction steps. In some embodiments, the phase separation may be performed under high temperature to increase an amount of polyphenols in the tea slurry produced in step 130. In some embodiments, the phase separation temperature may be within a range of about 2° C. to about 90° C. In some embodiments, the phase separation may be run at a high temperature within a range of about 30° C. to about 90° C., within a range of about 40° C. to about 90° C., within a range of about 45° C. to about 90° C., within a range of about 30° C. to about 99° C., within a range of about 40° C. to about 99° C., or within a range of about 45° C. to about 99° C. In some embodiments, the phase separation may be performed at a lower temperature to reduce the amount of oxidation required downstream as is discussed below. In some embodiments, the lower temperature may be within a range of about 0° C. to about 15° C., within a range of about 3° C. to about 10° C. within a range of about 3° C. to about 40° C., within a range of about 3° C. to about 45° C., within a range of about 2° C. to about 40° C., within a range of about 2° C. to about 45° C., or within a range of about 2° C. to about 50° C. In particular, temperature may impact phase separation in that a range of temperatures from cold to ambient to high. Temperature during phase separation can be utilized to optimize the types and amounts of components separated from the feed slurry. The temperature can thus be used to optimize the amount of components, such as polyphenols, that are involved in the oxidation reaction and resulting finished product color, described in more detail below. In some embodiments, the phase separation may be performed using centrifuges, decanters, belt presses, or any other tool capable of performing phase separation.

In step 140, the clarified tea extract may be concentrated or diluted to the desired tea extract solids level for the color adjustment. The concentrating may be performed, using a concentrating module, based on the amount of tea solids in the tea extract after the phase separation in step 130. The concentrating may be performed through any number of capable processes, such as, for example, reverse osmosis, membranes, evaporators, presses, or any combination thereof. The membranes may be ceramic. The evaporators may be thermal, vacuum, single stage, multi-stage, circulation, thermally-accelerated short-time, flash evaporators, or a combination thereof. The diluting may be performed by adding an additional amount water to the tea extract. The tea extract may then be further processed in step 140, while the tea solids may be saved for further use or discarded as waste. In some embodiments, the amount of tea solids in the tea extract may be in a range of 10%-20% (w/w), in a range of 10%-12% (w/w), in a range of 12%-15% (w/w), in a range of 5%-25% (w/w), or in a range of 2%-30% (w/w).

Steps 150-170 are reaction processes that are individually or collectively performed to react the tea extract produced during step 140. The reaction processes may be performed in a reaction module, such as in a reaction tank. In some embodiments, the reactions may be performed for one or more of enhancing color, reducing haze, improving cold water stability, and improving acid stability. At step 150, the tea extract undergoes oxidation for generating a darker color, thus producing an oxidized dark tea extract. In some embodiments, the oxidation comprises alkaline oxidation. Alkaline oxidation of the tea extract comprises several steps. First, the tea extract is heated using a heating module, for example, to reach a temperature within a range of about 75° C. to about 85° C. A strong base may then be added to the tea extract. In some embodiments, the base comprises one or more of barium hydroxide (Ba(OH)2), caesium hydroxide (CsOH), strontium hydroxide (Sr(OH)2), calcium hydroxide (Ca(OH)2), lithium hydroxide (LiOH), rubidium hydroxide (RbOH), potassium hydroxide (KOH), or sodium hydroxide (NaOH). The base may be added in an amount until the tea extract reaches a pH range of about 9 to about 12. In some embodiments, the oxidation is performed for about 1 to 15 minutes, for about 1 to 30 minutes, for about 1 to 45 minutes, for about 1 minutes to 60 minutes, for about 30 to 70 minutes, for about 40 to 70 minutes, for about 50 to 80 minutes, for about 60 to 90 minutes, for about 30 minutes to 90 minutes, for about 50 to 100 minutes, for about 70 to 100 minutes, or for about 90 minutes to 120 minutes.

Once the target pH is reached, the tea extract may then undergo sparging. In some embodiments, the sparging is performed using oxygen or a source of oxygen, such as, for example, ambient air. The sparging may be performed for a desired amount of time while monitoring the pH of the tea extract. In some embodiments, the sparging is performed for about 1 to 15 minutes, for about 1 to 30 minutes, for about 1 to 45 minutes, for about 1 minutes to 60 minutes, for about 30 to 70 minutes, for about 40 to 70 minutes, for about 50 to 80 minutes, for about 60 to 90 minutes, for about 30 minutes to 90 minutes, for about 50 to 100 minutes, for about 70 to 100 minutes, or for about 90 minutes to 120 minutes. In some embodiments, the sparging is performed at a rate of about 100-140 cubic feet per minute (CFM).

At step 160, the oxidized tea extract undergoes solubilization, to solubilize polymers and aid in fine tuning color adjustment and finished product haze. The polymers comprise polyphenols in the tea, which may be polymerized previously during the oxidation at step 150. In some embodiments, the solubilization comprises one or more of hydrogen peroxide (H₂O₂) solubilization or ozone solubilization. The H₂O₂ solubilization may be performed by pumping, for example, H₂O₂ into the oxidized tea extract and mixing the H₂O₂ and tea, to allow for a solubilization reaction. In some embodiments, amount of H₂O₂ added may be determined based on one or more of a percentage and/or type of the tea solids, a pH, and a color of the oxidized tea extract. In some embodiments, the solubilization is performed for about 1 to 15 minutes, for about 1 to 30 minutes, for about 1 to 45 minutes, for about 1 minutes to 60 minutes, for about 30 to 70 minutes, for about 40 to 70 minutes, for about 50 to 80 minutes, for about 60 to 90 minutes, for about 30 minutes to 90 minutes, for about 50 to 100 minutes, for about 70 to 100 minutes, or for about 90 minutes to 120 minutes. At the end of the solubilization, a pH of the solubilized tea extract may be recorded.

At step 170, the pH of the solubilized tea extract may require adjusting to obtain a desired final product pH. In some embodiments, the reacted tea extract pH may be adjusted to 5-7. pH adjusting may be performed by adding acid to the solubilized tea extract. In some embodiments, the solubilized tea extract may be transferred, e.g., pumped, into a separate container configured for adding acid. In some embodiments, the separate container comprises a mixing module, such as, for example, an agitator. In some embodiments, the solubilized tea extract is cooled before adding the acid, such as, for example, using a heat exchanger. In some embodiments, the solubilized tea extract is cooled to less than 45° C. In some embodiments, amount of acid added may be determined based on one or more of a pH, a color, a clarity, a flavor, and an acid stability of the solubilized tea extract. In some embodiments, the acid is sulfuric acid, hydrochloric acid, phosphoric acid, or citric acid. Once acid is added to the solubilized tea extract, the resulting mixture may be agitated or stirred while a pH is being monitored, and may continue until the pH is between about 5.5 and 6.5, thereby completing the reaction.

Step 180 comprises post-processing of the reacted tea extract to form the finished tea product. The post-processing may be performed based at least on evaluating the reacted tea extract. In particular, the evaluating may comprise measuring at least one feature of the reacted tea extract, such as, for example, a color and a haze of the reacted tea extract. In some embodiments, the post-processing of the reacted tea extract may include one or more of: centrifuging, evaporating, and drying. For example, if the haze is too great, the reacted tea slurry extract may be centrifuged to reduce the haze. In some embodiments, the color and/or haze are evaluated using a color measurement device, such as a colorimeter or spectrophotometer.

In some embodiments, a color and/or a haze of a tea product may be measured by a colorimeter or spectrophotometer on a CIELAB scale. The CIELAB scales includes an L value, which scales a lightness to a darkness value of a tea product, an A value, which scales a red to green color value of a tea product, and a B value, which scales a blue to yellow of a tea product. An application of the tea product determines the target color and haze of the tea that is made. Such applications include, for example, ready to drink tea, dry powder beverage mix, a carbonated beverage, dairy products, or baked food. In some embodiments, an L-value of the tea product ranges from between 1 to 5, from between 5 to 10, from between 10 to 20, from between 5 to 30, from between 20 to 30, from between 1 to 30, from between 1 to 35, from between 30 to 40, from between 10 to 35, from between 1 to 50, from between 40 to 50, from between 1 to 60, from between 50 to 60, from between 60 to 70, from between 70 to 80, from between 80 to 90, or from between 90 to 100. In some embodiments, an A-value of the tea product ranges from between 1 to 5, from between 5 to 10, from between 10 to 20, from between 5 to 30, from between 20 to 30, from between 1 to 30, from between 1 to 35, from between 30 to 40, from between 10 to 35, from between 1 to 50, from between 40 to 50, from between 1 to 60, from between 50 to 60, from between 60 to 70, from between 70 to 80, from between 80 to 90, or from between 90 to 100. In some embodiments, a B value of the tea product ranges from between 1 to 5, from between 5 to 10, from between 10 to 20, from between 5 to 30, from between 20 to 30, from between 1 to 30, from between 1 to 35, from between 30 to 40, from between 10 to 35, from between 1 to 50, from between 40 to 50, from between 1 to 60, from between 50 to 60, from between 60 to 70, from between 70 to 80, from between 80 to 90, or from between 90 to 100. In some embodiments, a haze value of the tea product ranges from between 1 to 5, from between 5 to 10, from between 10 to 20, from between 5 to 30, from between 20 to 30, from between 1 to 30, from between 1 to 35, from between 30 to 40, from between 10 to 35, from between 1 to 50, from between 40 to 50, from between 1 to 60, from between 50 to 60, from between 60 to 70, from between 70 to 80, from between 80 to 90, or from between 90 to 100.

Once the haze and color are at desired levels, the reacted tea extract may be concentrated such that the tea product has a desired level of total tea solids. In some embodiments the L value, A value, and haze may be further affected by adjusting an amount of oxidation that is performed. In some embodiments the L value, A value, and haze may be further affected by adjusting an amount of solubilization that is performed. In some embodiments, the amount of tea solids in the reacted tea extract to be in a range of about 25% to about 65% (w/w), in a range of about 35% to about 55% (w/w), in a range of 10%-20% (w/w), in a range of about 10% to about 12% (w/w), in a range of about 12% to about 15% (w/w), in a range of about 5% to about 25% (w/w), in a range of about 20% to about 70%, or in a range of about 2% to about 30% (w/w). In some embodiments, the resulting tea product is dried using one or more of spray drying, freeze drying, vacuum belt drying, and thermal spray drying.

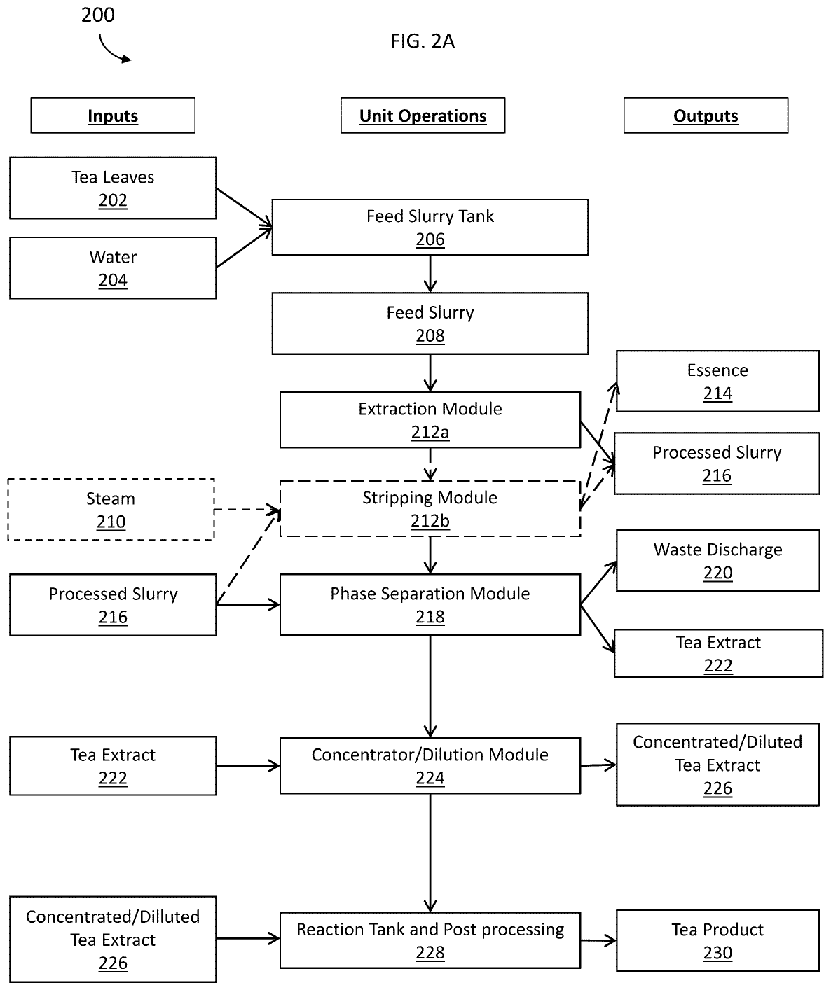

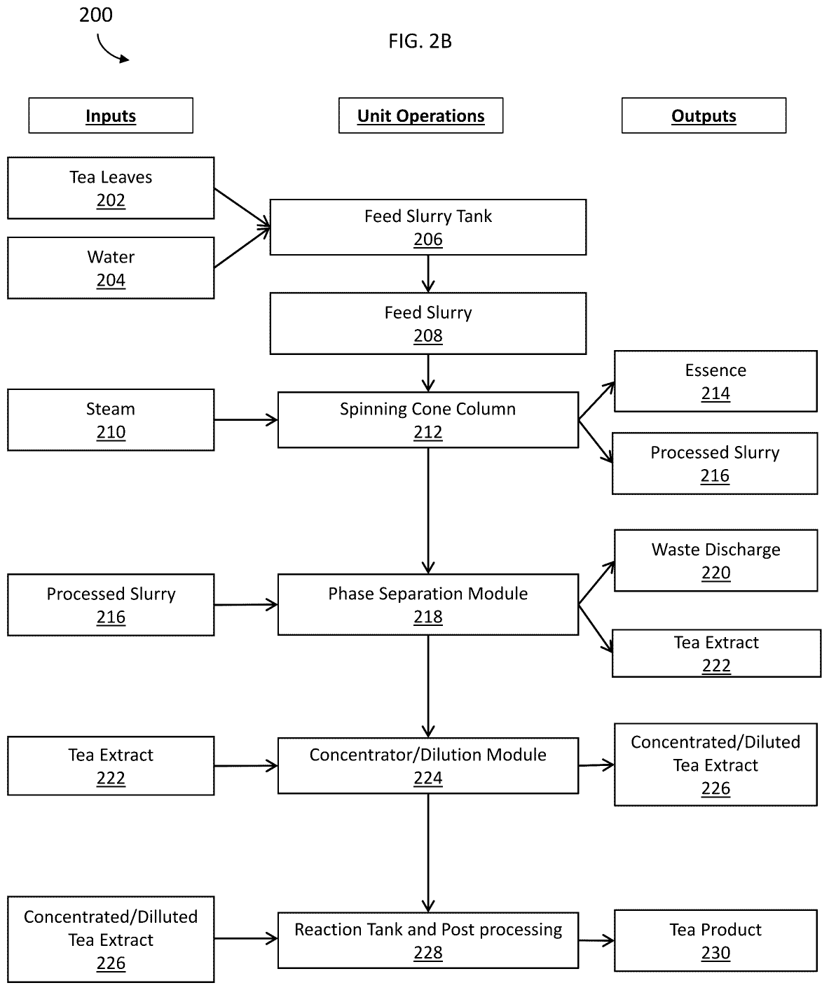

By way of nonlimiting embodiments, FIGS. 2A-2B illustrate systems 200 for performing process 100 in preparing a tea product of the present disclosure. Each component is delineated as either an input in the left column, a unit operation with transfer materials between operations in the middle column, or an output in the right column. FIG. 2A illustrates an exemplary system with an extraction module for performing an extracting step, and optionally, a separate stripping module for performing an optional stripping step. FIG. 2B illustrates an exemplary system with a combined module for performing extracting and, optionally, stripping, of a feed slurry. It should be noted that the system 200 is provided as an example only, and alternative unit of operations may be used in the system 200.

Fist, tea leaves 202 and water 204 may be added to a feed slurry tank 206, producing a feed slurry 208, e.g., a mixture of the tea leaves 202 and water 204. In some embodiments, tea leaves 202 comprises a single tea or a combination of different types of tea, such as, for example, black tea and green tea. In some embodiments, the tea leaves 202 may be combined, such as through a hopper, prior to entering into the slurry tank 206. A hopper or tank, for example slurry tank 206, may be used to combine the tea leaves 202 and water 204 while heating to a desired extraction temperature.

After it is formed, the feed slurry 208 may then be transferred for tea extraction. As shown in FIG. 2A, the feed slurry 208 is transferred to an extraction module 212a to produce a processed slurry 216. In some embodiments, the feed slurry 208 may pass through a heat exchanger prior to entering the extraction module 212a, such that the heat exchanger may pre-heat the feed slurry 208. The extraction module 212a may operate by extracting, via contact, soluble tea solids from the tea leaves 202 into the water 204. In some embodiments, the extraction module 212a may comprise a spinning cone column, batch extractor, counter-current extractor, or a combination thereof. In some embodiments, the temperature may be optimized by using a pressurized or vacuum reactor. In some embodiments, depending on a temperature of the extraction module 212a, some essence 214 containing the extracted aromas and/or flavors may be removed in the extraction module 212a.

After the extraction, the processed slurry 216 may be transferred to a stripping module 212b to be subject to tea stripping. In some embodiments, the stripping is performed by applying a stripping composition in combination with the feed slurry 208 to the stripping module 212b. In some embodiments, the stripping composition comprises steam 210, as shown in FIG. 2A. As an alternative to the steam 210, the stripping composition may comprise steam, air, inert gas, or a combination thereof. By applying the stripping composition to the stripping module 212b in combination with the feed slurry 208, volatile aromas, flavors, or both are stripped from the tea leaves 202 into the stripping composition. In some embodiments, the steam 210 containing the stripped aromas, flavors, or both is removed from the stripping module 212b using a condenser, which may operate by using chilled water to condense the steam 210 into water containing the volatile aromas and/or flavors, i.e., the essence 214. In some embodiments, the stripping module 212a may comprise a spinning cone column, a packed column, a tray column, or a combination thereof.

In some embodiments, as shown in FIG. 2B, the extraction and optional stripping can be carried out in a single module. By way of example, a spinning cone column (SCC) 212 can be used to carry out the extraction and the stripping steps to produce a processed slurry 216 wherefrom essence 214 is removed. In addition to extraction, the SCC 212 is capable of subjecting the feed slurry 208 to tea stripping as desired in the SCC 212 to form the processed slurry 216. In some embodiments, the stripping is performed by applying a stripping composition in combination with the feed slurry 208 to the SCC 212.

The processed slurry 216 may then be transferred to a phase separation module 218 for further phase separation of tea extract 222 from waste discharge 220, such as, for example, any undissolved tea solids. In some embodiments, the phase separation module 218 comprises one or more sub-modules, such as, for example, a decanter, a centrifuge, a filter, or a combination thereof. Each sub-module may be used to remove a different type of waste contributing to the waste discharge 220. The decanter may allow for removal of insoluble tea leaf solids, the centrifuge may allow for removal of centrifuge waste discharge comprising a mixture of additional insoluble solids, oil, and some liquid tea extract, and the filter may allow for removable of filter waste discharge comprising further insoluble solids. In some embodiments, the tea extract 222 may cycle through the phase separation module 218 to perform a plurality of phase separation steps.

After the phase separation module 218, the tea extract 222 may then be transferred to a concentrator/dilution module 224 for one or more of concentrating or diluting to obtain a desired amount of tea solids to produce a concentrated/diluted tea extract 226. In some embodiments, the concentrator/dilution module 224 comprises an evaporator, a pump, a feed tank, a membrane system, a press, a reverse osmosis system, or a combination thereof. The membranes may be ceramic. The evaporators may be thermal, vacuum, single stage, multi-stage, circulation, thermally-accelerated short-time, flash evaporators, or a combination thereof. The evaporator may be used to concentrate the tea extract 222 into a thick, concentrated liquid tea, using steam as an input to heat the evaporator and facilitate the concentrating. The evaporator may also use vacuum to lower the boiling point of the tea extract 222 to aid in evaporation or concentration processes. The evaporator may produce condensate as a byproduct, whereby the condensate may contain some additional volatile aromas and/or flavors. In some embodiments, the pump may be used to transfer tea extract 222 into totes for storage or shipping as desired for further use. In some embodiments, an additional tank may be used as a vessel for diluting the tea extract 222 as necessary, such as, for example, to produce an amount of tea solids in the tea extract 222 to be in a range of 10%-20% (w/w). Water may be added to the feed tank for the diluting.

The product of the concentrator/dilution module 224 is indicated as a concentrated/diluted tea extract 226, which is then transferred to the reaction tank 228 for undergoing at least one reaction, such as oxidizing, solubilizing, and adjusting a pH. In some embodiments, the reaction tank 228 comprises a heating module, a sparging module, a heat exchanger, at least one pump, or a combination thereof. In some embodiments, the concentrated tea extract 226 may be processed through the heat exchanger after the solubilizing reaction so as to cool the concentrated tea extract 226. In some embodiments, the reaction tank 228 comprises a plurality of input channels to receiving inputs such as a base, air, a solubilizer, an acid, or a combination thereof to perform each of the at least one reaction. For example, the base may be used to oxidize the concentrated tea extract 226, the solubilizer may be used to solubilize polymers in the concentrated tea extract 226, and the acid may be used to adjust the pH of the concentrated tea extract 226. In some embodiments, the concentrator/dilution module 224 further comprises a sparging submodule. In some embodiments, the sparging submodule uses oxygen or a source of oxygen, such as, for example, ambient air.

In some embodiments, the concentrator/dilution module 224 comprises a mixing module, such as, for example, an agitator. In some embodiments, the concentrator/dilution module 224 comprises a heat exchanger.

After the reactions are performed accordingly, the products may optionally be subjected to post-processing, whereby a final tea product is harvested as a tea product 230. In some embodiments, the post-processing comprises evaluating the reacted tea extract produced from the reaction tank 228, then transferring the reacted tea extract to a centrifuging submodule, a concentrator submodule, a drying submodule, or a combination thereof. In some embodiments, the reaction tank 228 comprises a color measurement device, such as a colorimeter or spectrophotometer. The centrifuging submodule may be used to reduce any potential haze as desired. The concentrator submodule may be used to further concentrate the reacted tea extract as desired, such as, for example, to produce an amount of tea solids in the reacted tea extract to be in a range of about 25% to about 65% (w/w), in a range of about 35% to about 55% (w/w), in a range of 10%-20% (w/w), in a range of about 10% to about 12% (w/w), in a range of about 12% to about 15% (w/w), in a range of about 5% to about 25% (w/w), in a range of about 20% to about 70%, or in a range of about 2% to about 30% (w/w). In some embodiments, the reacted tea extract may be transferred back to the concentrator module 224 to concentrate the reacted tea extract as desired. In some embodiments, the drying submodule uses one or more of spray drying, freeze drying, vacuum belt drying, and thermal spray drying. The drying submodule may be used to spray dry the reacted tea extract to obtain a desired dried finished product.

### Coloring Agents

The present disclosure provides methods and systems for preparing a food coloring or food coloring agent. In some embodiments, the methods and systems of the present disclosure allows for an adjustment of one or more of color, aroma, and flavor of the coloring agent to use such adjusted coloring agent for enhancing one or more of color, aroma, or flavor of a food product in a cost-effective and natural manner.

In some embodiments, the systems and methods comprises combining tea leaves and water to form a feed slurry. In some embodiments, the method comprises processing the feed slurry to at least partially remove a tea essence from the feed slurry, thereby obtaining a tea extract with a predetermined amount of one or more of an aroma or a flavor. In some embodiments, the method comprises adjusting a color of the tea extract, thereby obtaining a coloring agent with a predetermined color-related feature. In some embodiments, the coloring agent is added in a predetermined amount to a food product to adjust a color of the food product.

In some embodiments, the agent composition includes a dry tea extract, wherein a color-related feature of the dry tea extract scales with an amount of solid-liquid extraction, oxidation, solubilization, and pH adjustment of a tea feed slurry. In some embodiments, the tea feed slurry comprises a mixture of tea leaves and water.

In some embodiments, the coloring agent includes a dry tea extract. In some embodiments, an essence of the dry tea extract has been removed from the dry tea extract to a predetermined amount. In some embodiments, a color of the dry tea extract has been adjusted to have a predetermined color-related feature. In some embodiments, a color-related feature comprises one or more of an L-value, an A-value, a B-value, a haze value, or a combination thereof.

In some embodiments, the method further comprises adding a coloring agent, e.g., a tea extract, to a food product. The coloring agent may be added to a food product based on a desired feature to be imparted to the food product. For example, in some embodiments, the desired feature may be a color-related feature of the coloring agent. In some embodiments, the desired feature may be a flavor of the coloring agent. In some embodiments, the desired feature may be an aroma of the coloring agent. In some embodiments, the coloring agent may be adjusted to have a desired combination of the color related feature, flavor and aroma to impart a desired combination of these properties to a food product.

In some embodiments, the food product comprises a batter, beer, bread, buns, cereals, chocolate, cookies, pastries, cough drops, spirits, liquor, confectionery, coatings, custards, decorations, fillings and toppings, potato chips, dessert mixes, doughnuts, fish and shellfish spreads, frozen desserts, condiments, pet foods, preserves, tablets, gravy, ice cream, sauces and dressings, soft drinks, sweets, vinegar, soups, teas, juice concentrates, crackers, or flavorings.

In some embodiments, a desired feature of a coloring agent is affected by various factors. In some embodiments, a color-related feature of a coloring agent is affected by a ratio of black tea and green tea in the tea leaves of the feed slurry. In some embodiments, a ratio of black tea and green tea affect a level of tea polyphenols in the feed slurry. As discussed throughout this disclosure, the more tea polyphenols that are present in the feed slurry, the more tea polyphenols are available for oxidation reactions, which may allow for darkening and/or affecting an L-value of a coloring agent.

In some embodiments, a color-related feature of a coloring agent is affected by a phase separation of the tea extract. A phase separation may be performed under high temperature to increase an amount of polyphenols in the tea slurry, or at a lower temperature to reduce an amount of polyphenols, thus reducing an amount of oxidation required to adjust a color of the tea extract. In particular, temperature during phase separation allows for control over an amount of components, such as polyphenols, that are involved in the oxidation reaction and resulting finished product color. In some embodiments, a color-related feature of a coloring agent is affected by a concentrating or diluting of a tea extract to a desired level of solids and/or polyphenols for the color adjustment.

In some embodiments, a color-related feature of a coloring agent is affected by one or more reaction processes that are individually or collectively performed to react a tea extract. For example, a color-related feature of a coloring agent may be affected by an oxidation reaction, which may generate a darker color. A color-related feature of the coloring agent may further be affected by a duration of an oxidation reaction. In some embodiments, a color-related feature of a coloring agent is affected by sparging. In some embodiments, a color-related feature of a coloring agent is affected by a solubilization reaction, which solubilizes polymers and aids in fine tuning color adjustment and finished product haze. In some embodiments, an amount of solubilization may be determined based on one or more of a percentage and/or type of the tea solids, a pH, and a color of the tea extract.

In some embodiments, a color-related feature of a coloring agent is affected by post-processing of a tea extract. Post-processing may be performed based at least on evaluating a tea extract. For example, if a haze is too great, a tea extract may be centrifuged to reduce the haze.

In some embodiments, a flavor and/or aroma of a coloring agent is affected by various factors. In particular, a flavor and/or aroma of a coloring agent may be affected by an amount of essence (i.e., tea essence) remaining in a coloring. In some embodiments, a remaining essence in a coloring agent may be affected by an extracting. For example, an essence may include soluble and/or volatile components, e.g., an aroma, flavors, and other volatile components or non-volatile components from tea in a feed slurry. In some embodiments, a remaining essence in a coloring agent may affected by a temperature of a tea extracting. In some embodiments, extracting is continued until the desired amounts of tea essence and extract are obtained. In some embodiments, a remaining essence in a coloring agent may be affected by stripping. For example, stripping may remove additional essence from a feed slurry or tea extract, whereby the additional essence may comprise further stripping soluble and/or volatile components from the tea. A stripping composition, which is exposed to the tea extract during the stripping, may be then condensed to collect the tea essence for further use in flavor or aroma-related applications. In some embodiments, the tea stripping is continued until the desired amounts of tea essence and extract are obtained.

In some embodiments, a flavor and/or aroma of a coloring agent is affected by a concentration of a tea extract to a desired tea extract solids level. In some embodiments, a flavor and/or aroma of a coloring agent is affected by a diluting of a tea extract to a desired tea extract solids level for the flavor adjustment. In some embodiments, a flavor and/or aroma of a coloring agent is affected by a pH of a tea extract.

By way of nonlimiting examples, described herein is a method of producing a food product comprising a coloring agent described herein, where one or more of a color-related feature, a flavor, or an aroma of the food product are adjusted based on the coloring agent. For example, when producing an iced tea, the coloring agent may be affected by adjusting the levels of oxidation and solubilization so as to desired color-related features including, for example, an L value from 5-28, an A value from 15-40, and a haze value from 5-20. A flavor and/or aroma of the coloring agent are also affected by adjusting an amount of extraction and/or stripping that are performed on a feed slurry to remove essence from the resulting tea extract.

In some embodiments, as a result of adding the coloring agent to water, along with any other additives, the flavor and/or aroma of the iced tea may be affected by an amount of essence that has been removed from the coloring agent, and will have a color based on the resulting levels of color-related features of the coloring agent. The coloring agent may also be added in differing amounts so as to further adjust a color-related feature, flavor or aroma of the iced tea. In some embodiments, the iced tea may be made by adding the removed essence to the iced tea. The essence may be added in differing amounts to further adjust a flavor and/or aroma profile of the iced tea.

### Computer Implementation

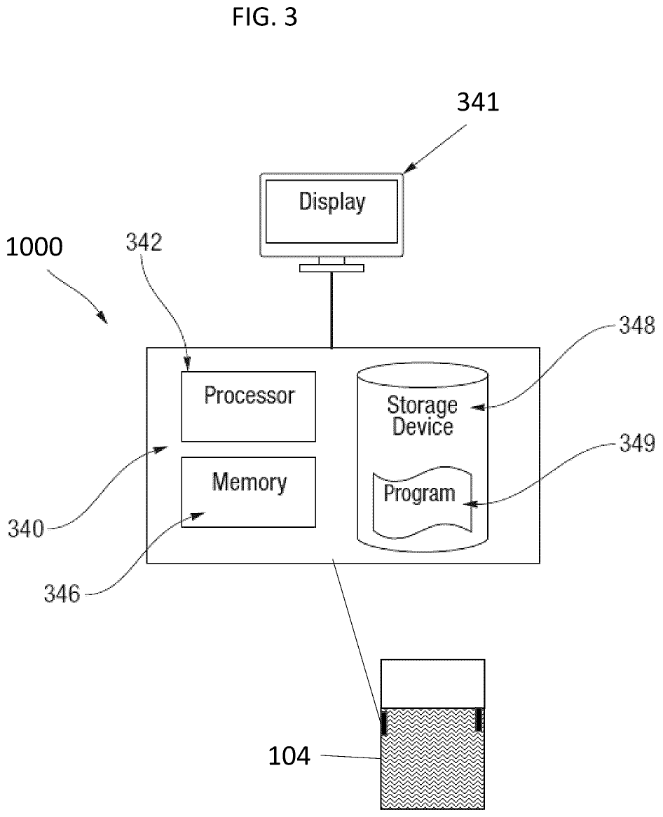

FIG. 3 shows, by way of example, a diagram of a typical processing architecture for an automated computer system 1000, which may be used in connection with the methods and systems of the present disclosure. In some embodiments, tea feature data, such as pH, temperature, etc., may be collected to monitor such features during each process step. In some embodiments, the tea feature data may be collected using on-line one or more sensors or off line, such as for, example, taking a sample from the reaction tank and testing the sample using an HPLC. The tea feature data can be communicated to a computer system 1000, in particular, a processor 342, that is programed to perform one or more steps of the methods described above. For example, the processor may be programmed to receive the tea feature data, or when pH or temperature of the source material liquid reach a desired level. A computer processing device 340 can be coupled to display 341 for graphical output. Processor 342 can be a computer processor 342 capable of executing software. Typical examples can be computer processors (such as Intel® or AMD® processors), ASICs, microprocessors, and the like. Processor 342 can be coupled to memory 346, which can be typically a volatile RAM memory for storing instructions and data while processor 342 executes. Processor 342 may also be coupled to storage device 348, which can be a non-volatile storage medium, such as a hard drive, FLASH drive, tape drive, DVDROM, or similar device. Although not shown, computer processing device 340 typically includes various forms of input and output. The I/O may include network adapters, USB adapters, Bluetooth radios, mice, keyboards, touchpads, displays, touch screens, LEDs, vibration devices, speakers, microphones, sensors, or any other input or output device for use with computer processing device 340. Processor 342 may also be coupled to other types of computer-readable media, including, but not limited to, an electronic, optical, magnetic, or other storage or transmission device capable of providing a processor, such as the processor 342, with computer-readable instructions. Various other forms of computer-readable media can transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Program 349 can be a computer program or computer readable code containing instructions and/or data and can be stored on storage device 348. The instructions may comprise code from any computer-programming language, including, for example, C, C++, C#, Visual Basic, Java, Python, Perl, and JavaScript. In a typical scenario, processor 342 may load some or all of the instructions and/or data of program 349 into memory 346 for execution. Program 349 can be any computer program or process including, but not limited to web browser, browser application, address registration process, application, or any other computer application or process. Program 349 may include various instructions and subroutines, which, when loaded into memory 346 and executed by processor 342 cause processor 342 to perform various operations, some or all of which may effectuate the methods for managing the process disclosed herein. The program 349 may be stored on any type of non-transitory computer readable medium, such as, without limitation, hard drive, removable drive, CD, DVD or any other type of computer-readable media.

### EXAMPLES

The following examples are included for illustrative purposes only and are not intended to limit the scope of the invention.

### Example 1: Process for Measuring Color of Tea Product

The purpose of this example is to provide a method of measuring a color feature of a tea product.

Synthetic hard water was prepared for testing to standardize tap water based on tea solids reacting differently with varying hardness. Harder water is generally known to cause increased haze. Solutions of 31 g/L sodium bicarbonate, 75 g/L magnesium sulfate, and 89.5 g/L calcium chloride were prepared separately. 38 mL of each of these solutions were added to a 20 L deionized (DI) water to make the synthetic hard water.

A color of a tea product was measured as represented by a “Colour Value L”, completed using a Vista® Spectrophotometer from HunterLab® using a CIELAB scale with the parameters set as Haze % (indices), D65/10 (illuminant) and using a 20 mm large format cell.

The sample for measuring the color was 0.175 g of tea product dissolved in 200 ml of synthetic hard water and letting it sit for 1 minute prior to testing. The measurement was performed at 15° C.

Many modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the present disclosure. It is intended that the present disclosure be limited only to the extent required by the appended claims and the applicable rules of law.

It is also to be understood that the following claims are to cover all generic and specific features of the present disclosure described herein, and all statements of the scope of the present disclosure which, as a matter of language, might be said to fall therebetween.

1. A method for food coloring, the method comprising:
combining tea leaves and water to form a feed slurry;
processing the feed slurry to at least partially remove a tea essence from the feed slurry, thereby obtaining a tea extract with a predetermined amount of one or more of an aroma or a flavor; and
adjusting a color of the tea extract, thereby obtaining a coloring agent with a predetermined color-related feature;
wherein the coloring agent is added in a predetermined amount to a food product to adjust a color of the food product.

2. The method of claim 1, further comprising adding the coloring agent to a food product.

3. The method of claim 2, wherein the food product comprises a batter, beer, bread, buns, cereals, chocolate, cookies, pastries, cough drops, spirits, liquor, confectionery, coatings, custards, decorations, fillings and toppings, potato chips, dessert mixes, doughnuts, fish and shellfish spreads, frozen desserts, condiments, pet foods, preserves, tablets, gravy, ice cream, sauces and dressings, soft drinks, sweets, vinegar, soups, teas, juice concentrates, crackers, or flavorings.

4. The method of claim 1, wherein the tea leaves comprise black tea, green tea, or a combination thereof.

5. The method of claim 1, wherein the processing comprises performing at least one tea extraction of the feed slurry.

6. The method of claim 5, wherein the processing further comprises performing at least one tea stripping of the feed slurry, wherein the at least one tea stripping comprises exposing the feed slurry to steam, air, inert gas, or a combination thereof.

7. The method of claim 6, wherein the at least one tea extraction and the at least one tea stripping are performed simultaneously.

8. The method of claim 6, wherein the at least one tea extraction and the at least one tea stripping are performed sequentially.

9. The method of claim 5, wherein the at least one tea extraction comprises extracting soluble and/or volatile components from the tea leaves.

10. The method of claim 5, wherein the at least one tea extraction is performed using a spinning cone column, a batch extractor, counter-current extractor, or a combination thereof.

11. The method of claim 1, wherein the processing comprises at least one phase separation, the at least one phase separation being performed using a decanter, filtration, centrifugation, or a combination thereof.

12. The method of claim 11, wherein the at least one phase separation is between each of at least one tea extraction step.

13. The method of claim 11, wherein the at least one phase separation is performed at a temperature within a range of 40° C. to 90° C. to increase an amount of polyphenols in the tea extract.

14. The method of claim 11, wherein the at least one phase separation is performed at a temperature within a range of 3° C. to about 40° C. to reduce an amount of polyphenols in the tea extract.

15. The method of claim 11, further comprising concentrating or diluting the tea extract after the performing the at least one phase separation so as to obtain an amount of tea solids in a range of 10%-20% in the tea extract.

16. The method of claim 15, wherein the concentrating is performed using reverse osmosis, membranes, evaporators, presses, or a combination thereof.

17. The method of claim 15, wherein the diluting is performed by adding water to the tea extract.

18. The method of claim 1, wherein the adjusting the color comprises one or more of oxidizing of the tea extract, solubilizing of the tea extract, adjusting a pH of the solubilized tea extract, or a combination thereof.

19. The method of claim 18, the oxidizing comprises alkaline oxidation.

20. The method of claim 18, wherein the solubilizing comprises hydrogen peroxide (H₂O₂) solubilization, ozone solubilization, or a combination thereof.

21. The method of claim 18, wherein the adjusting the pH comprises adding an amount of acid sufficient to adjust the pH of the solubilized tea extract to between 5-7.

22. The method of claim 1, further comprising concentrating the coloring agent so as to obtain an amount of tea solids in a range of about 25% to about 65% (w/w).

23. The method of claim 1, further comprising post-processing of the coloring agent, wherein the post-processing comprises one or more of centrifuging, evaporating, drying, or a combination thereof of the coloring agent.

24. The method of claim 23, wherein the drying comprises one or more of spray drying, freeze drying, vacuum belt drying, thermal spray drying, or a combination thereof.

25. A system for food coloring, comprising:
a processing module configured to at least partially remove a tea essence from a feed slurry, thereby obtaining a tea extract with a predetermined amount of one or more of an aroma or a flavor, the feed slurry comprising tea leaves and water; and
a reaction module configured to adjust a color of the tea extract, thereby obtaining a coloring agent with a predetermined color-related feature.

26.-40. (canceled)

41. A coloring composition comprising:
a dry tea extract, wherein a color-related feature of the dry tea extract scales with an amount of solid-liquid extraction, oxidation, solubilization, and pH adjustment of a tea feed slurry;
wherein the color-related feature comprises one or more of an L-value ranging from between 5 and 28, an A-value ranging from between 15 and 40, a haze value ranging from between 5 and 20, or a combination thereof; and
wherein the tea feed slurry comprises a mixture of tea leaves and water.

42.-44. (canceled)

45. A coloring composition comprising:
a dry tea extract, wherein an essence has been removed from the dry tea extract to a predetermined amount, and a color of the dry tea extract has been adjusted to have a predetermined color-related feature, the color-related feature being one or more of an L-value ranging from between 5 and 28, an A-value ranging from between 15 and 40, a haze value ranging from between 5 and 20, or a combination thereof.

46.-49. (canceled)
